(19) United States
(12) Patent Application Publication
(10) Pub. No.: US 2025/0051652 A1
(43) Pub. Date: Feb. 13, 2025

(54) SYSTEMS AND METHODS FOR REMOVAL OF CONTAMINANTS FROM PYROLYSIS OIL DURING TRANSPORT

(71) Applicant: SABIC Global Technologies B.V., Bergen OP Zoom (NL)

(72) Inventors: Fabrice Cuoq, Geleen (NL); Martijn Marcel Margaret Frissen, Geleen (NL); Carlo Jozef Maria Geijselaers, Geleen (NL)

(21) Appl. No.: 18/719,544

(22) PCT Filed: Dec. 13, 2022
(86) PCT No.: PCT/IB2022/062134

§ 371 Date: Jun. 13, 2024

Related U.S. Application Data
(60) Provisional application No. 63/265,327, filed on Dec. 13, 2021.

(51) Int. Cl. C10G 25/05; C10G 25/06

(52) U.S. Cl. CPC C10G 25/05; C10G 25/06; C10G 2300/1007

(57) ABSTRACT

Provided here are methods and systems for treatment of a hydrocarbon feedstock fluid during transportation to reduce contaminants harmful to refinery cracking units. Methods include transporting a contaminated hydrocarbon feedstock fluid in a transport container outfitted with removable units containing an adsorbent. The removable units can be exchanged to provide fresh adsorbent, or configured to treat specific contaminants present in the hydrocarbon feedstock fluid.

### CROSS-REFERENCE TO RELATED APPLICATIONS

This application claims the benefit of and priority to U.S. Provisional Application No. 63/265,327, filed on Dec. 13, 2021, which is incorporated herein by reference in its entirety.

### TECHNICAL FIELD

The present disclosure generally relates to methods for the removal of contaminants from a hydrocarbon feedstock fluid during transport. More specifically, the present disclosure relates to the addition of an adsorbent to the bulk hydrocarbon fluid using removable units to allow the capture of undesired contaminants during vehicular transport.

### BACKGROUND

Hydrocarbon liquids are feedstock for cracking units to produce high value products. Hydrocarbon liquids, like pyrolysis oil, naphtha, and gas condensates, come from a multitude of sources and have a range of compositions and contaminants. Cracker operators attempt to select and specify certain parameters of these hydrocarbon liquids to minimize the negative effects of feedstock quality on cracker performance. In tension with the need to control the quality of the feedstock is the low cost of poorer quality hydrocarbon liquids. Managing the balance of cost versus acceptable quality results in significant efforts to test and approve liquid hydrocarbon feeds prior to introduction within the refinery environment.

The removal of small quantities of contaminants from the fluid being transported is a challenge on a large scale. As such halogen, nitrogen, sulfur, and metallic compounds may be present in the feedstock provided to refinery units performing fluid catalytic cracking (FCC), steam cracking (SC), hydrotreating (HT), hydrocracking (HC), and/or distillation. The presence of these compounds and their derivatives are deleterious to refinery operating units by causing elevated corrosion of construction materials, deactivation of catalysts through poisoning, and downtime due to more frequent maintenance shutdowns.

### SUMMARY

Embodiments include systems and methods of pretreating a hydrocarbon feedstock fluid in a transport container to produce a pretreated hydrocarbon feedstock fluid. One such method includes the steps of supplying a hydrocarbon feedstock fluid containing at least one contaminant to a transport container configured to transport the hydrocarbon feedstock fluid in bulk to a hydrocarbon processing facility, and contacting the hydrocarbon feedstock fluid with an adsorbent contained within a removable unit positioned inside the transport container. The removable unit is configured to provide fluid communication between the hydrocarbon feedstock fluid and the adsorbent. The method further includes the step of causing deposition of a portion of the at least one contaminant from the hydrocarbon feedstock fluid onto the adsorbent to produce a pretreated hydrocarbon feedstock fluid containing a reduced amount of the at least one contaminant. The at least one contaminant can be one or more of diolefin compounds, oxygen compounds, nitrogen compounds, or halogen compounds.

The method results in a reduction of about 10 weight percent (wt. %) or more of one or more of diolefin compounds, oxygen compounds, nitrogen compounds, or halogen compounds present in the hydrocarbon feedstock fluid. In some embodiments, the reduction of the one or more of the diolefin compounds, the oxygen compounds, the nitrogen compounds, or the halogen compounds present in the hydrocarbon feedstock fluid can range from about 10 wt. % to about 60 wt. %. In certain embodiments, the removable unit includes a plurality of channels that provides the fluid communication between the hydrocarbon feedstock fluid and the adsorbent. In certain embodiments, the method includes transporting the transport container to the hydrocarbon processing facility while contacting the hydrocarbon feedstock fluid with the adsorbent to provide circulation within the transport container.

In certain embodiments, the hydrocarbon feedstock fluid is raw mixed plastic waste pyrolysis oil. In certain embodiments, the hydrocarbon feedstock fluid is naphtha or gas condensate. In certain embodiments, the adsorbent in the removable unit includes an aluminosilicate or a silica based material to remove the one or more of the diolefin compounds, the oxygen compounds, the nitrogen compounds, or the halogen compounds from the hydrocarbon feedstock fluid. In certain embodiments, the removable unit contains a molecular sieve adsorbent to remove the one or more of diolefin compounds, oxygen compounds, nitrogen compounds, or halogen compounds from the hydrocarbon feedstock fluid. In certain embodiments, the adsorbent in the removable unit includes a solid base or an anionic exchange resin to remove at least one oxygen compound of the oxygen compounds from the hydrocarbon feedstock fluid. In certain embodiments, the adsorbent in the removable unit includes one or more of a solid acid, a zeolite, or a cationic exchange resin to remove at least one halogen compounds of the halogen compounds from the hydrocarbon feedstock fluid. In certain embodiments, the removable unit contains an activated carbon adsorbent to remove the one or more of the diolefin compounds, the oxygen compounds, the nitrogen compounds, or the halogen compounds from the hydrocarbon feedstock fluid.

Certain embodiments of a method of pretreating a hydrocarbon feedstock fluid in a transport container to produce a pretreated hydrocarbon feedstock fluid include supplying a hydrocarbon feedstock fluid containing two or more contaminants to a transport container configured to transport the hydrocarbon feedstock fluid in bulk to a hydrocarbon processing facility, followed by contacting the hydrocarbon feedstock fluid with a first adsorbent contained within a first removable unit positioned inside the transport container, and contacting the hydrocarbon feedstock fluid with a second adsorbent contained within a second removable unit positioned inside the transport container. The first removable unit is configured to provide fluid communication between the hydrocarbon feedstock fluid and the first adsorbent. The second removable unit is configured to provide fluid communication between the hydrocarbon feedstock fluid and the second adsorbent. The method further includes the step of causing deposition of a portion of a first contaminant from the hydrocarbon feedstock fluid onto the first adsorbent and deposition of a portion of a second contaminant from the hydrocarbon feedstock fluid onto the second adsorbent to produce a pretreated hydrocarbon feedstock fluid containing reduced amounts of the first contaminant and the second contaminant.

In certain embodiments, the two or more contaminants are diolefin compounds, oxygen compounds, nitrogen compounds, halogen compounds, or combinations thereof. In certain embodiments, the hydrocarbon feedstock fluid is raw mixed plastic waste pyrolysis oil. In certain embodiments, the hydrocarbon feedstock fluid is naphtha or gas condensate. In certain embodiments, the first adsorbent in the first removable unit is activated carbon, aluminosilicate, or silica based materials to remove at least one of the diolefin compounds, the oxygen compounds, the nitrogen compounds, or the halogen compounds from the hydrocarbon feedstock fluid. In certain embodiments, the first adsorbent in the first removable unit is a solid base or an anionic exchange resin to remove at least one oxygen compound of the oxygen compounds from the hydrocarbon feedstock fluid and the second adsorbent in the second removable unit is one or more of a solid acid, a zeolite, or a cationic exchange resin to remove at least one halogen compound of the halogen compounds from the hydrocarbon feedstock fluid. In certain embodiments, the second adsorbent in the second removable unit is a solid base or an anionic exchange resin to remove the one or more of an oxygen compound present in the hydrocarbon feedstock fluid. In certain embodiments, the second adsorbent in the second removable unit is one or more of a solid acid, a zeolite, or a cationic exchange resin to remove at least one halogen compound of the halogen compounds from the hydrocarbon feedstock fluid.

Certain embodiments of a method of pretreating a hydrocarbon feedstock fluid in a transport container by supplying a hydrocarbon feedstock fluid containing at least one contaminant to a transport container configured to transport the hydrocarbon feedstock fluid in bulk to a hydrocarbon processing facility, followed by contacting the hydrocarbon feedstock fluid with an adsorbent present as a fixed bed within a circulation system positioned inside the transport container, and causing deposition of a portion of the at least one contaminant from the hydrocarbon feedstock fluid onto the adsorbent to produce a pretreated hydrocarbon feedstock fluid containing a reduced amount of the at least one contaminant. The circulation system is equipped with a pump to circulate the hydrocarbon feedstock fluid through the fixed bed of the adsorbent.

In certain embodiments, the at least one contaminant is one or more of diolefin compounds, oxygen compounds, nitrogen compounds, or halogen compounds. In certain embodiments, the hydrocarbon feedstock fluid is raw mixed plastic waste pyrolysis oil. In certain embodiments, the hydrocarbon feedstock fluid is naphtha or gas condensate. In certain embodiments, the adsorbent in the fixed bed includes one or more of an aluminosilicate or a silica based material to remove the one or more of the diolefin compounds, the oxygen compounds, the nitrogen compounds, or the halogen compounds from the hydrocarbon feedstock fluid. In certain embodiments, the adsorbent in the fixed bed includes one or more of a solid base or an anionic exchange resin to remove at least one oxygen compound of the oxygen compounds from the hydrocarbon feedstock fluid. In certain embodiments, the adsorbent in the fixed bed includes one or more of a solid acid, a zeolite, or a cationic exchange resin to remove at least one halogen compound of the halogen compounds from the hydrocarbon feedstock fluid. In certain embodiments, the fixed bed contains an activated carbon adsorbent to remove the one or more of the diolefin compounds, the oxygen compounds, the nitrogen compounds, or the halogen compounds from the hydrocarbon feedstock fluid.

Aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a diagrammatic representation of a method of contacting a contaminated hydrocarbon feedstock with an adsorbent for the removal of contaminants to create a pretreated hydrocarbon feedstock during vehicular transport, according to an embodiment.

FIG. 2 is a diagrammatic representation of a method of contacting a contaminated hydrocarbon feedstock with a first adsorbent and a second adsorbent for the removal of a first contaminant and a second contaminant to create a pretreated hydrocarbon feedstock during vehicular transport, according to an embodiment.

FIG. 3 is a diagrammatic representation of a method of contacting a contaminated hydrocarbon feedstock with an adsorbent present as a fixed bed within a circulation system positioned within the transport container, according to an embodiment.

FIG. 4A is a diagrammatic representation of transport container, such as a tank truck, that includes removable units containing an adsorbent to remove contaminants from a hydrocarbon feedstock fluid in additional to a containment unity to secure the removable units within the transport container. The containment unity is equipped with an opening on the top of the transport container for inserting or extracting the removable units, according to an embodiment.

FIG. 4B is a diagrammatic representation of the containment unity that includes a housing unit encasing the removable units, the housing unit being cylindrical with a plurality of openings to allow for fluid communication between the removable units and the hydrocarbon feedstock fluid, according to an embodiment.

FIG. 4C is a diagrammatic representation of the containment unity which includes a rack unit supporting the removable units, the rack being open to allow for fluid communication between the removable units and the hydrocarbon feedstock fluid, according to an embodiment.

### DETAILED DESCRIPTION

The present disclosure describes various embodiments related to systems, methods, and devices for removing contaminants from a hydrocarbon feedstock fluid prior to processing within a hydrocarbon processing facility. These systems, methods, and devices remove contaminants within a transport container during transport to produce a pretreated hydrocarbon feedstock fluid.

The description may use the phrases “in certain embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous. The term “plurality” as used herein refers to two or more items or components. The term “about” or “approximately” are defined as being close to as understood by one of ordinary skill in the art. In one non-limiting embodiment, these terms are defined to be within 10%, preferably within 5%, more preferably within 1%, and most preferably within 0.5%.

The terms “removing,” “removed,” “reducing,” “reduced,” or any variation thereof, when used in the claims and/or the specification includes any measurable decrease of one or more components in a mixture to achieve a desired result. The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.” The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

Embodiments of methods and devices described here are utilized to decontaminate a hydrocarbon feedstock fluid containing diolefin compounds, oxygen compounds, nitrogen compounds, and/or halogen compounds by adsorption using an adsorbent configured within a transport container. In certain embodiments, the contaminants originate from a depolymerized mixed plastic waste feed that includes small amounts of one or more halogenated polymers and formulated polymers containing halogen, nitrogen, sulfur, and metallic additives. In certain embodiments, the contaminants are present in low quality naphtha or gas condensates feedstocks.

In certain embodiments, the adsorbent is contained within removable units that are secured within the transport container by a containment unity. In certain embodiments, the containment unity is secured to a specific location within the transport container and is made up of a housing unit and removable units retained therein. In certain embodiments, the containment unity is secured to a specific location within the transport container and is made up of a rack unit and removable units retained therein. In certain embodiments, the transport container is equipped with at least one containment unity.

In certain embodiments, the removable units are modular to be added separately or in groups to the housing unit, which immobilizes the removable units. In certain embodiments, the housing unit can be a rigid structure of compatible shape to the removable units, which contain a plurality of channels to allow for fluid communication between the hydrocarbon feedstock fluid and the removable units. In certain embodiments, the removable units are modular to be added separately or in groups to a rack unit, which immobilizes the removable units against the momentums and inertias of the adsorbent saturated with hydrocarbon feedstock fluid generated during transport motion. In certain embodiments, the rack unit can be a rack with a minimal structure or skeletal structure to allow for maximal fluid communication between the hydrocarbon feedstock fluid and the removable units. In certain embodiments, the containment unity is configured to provide resistance to the momentum and inertial forces of the removable units when saturated with hydrocarbon feedstock fluid and subject to transport motion. In certain embodiments, the housing unit and the rack unit are made of chemically and mechanically compatible materials to the hydrocarbon feedstock fluid, such as materials that are inert or non-reactive to the hydrocarbon feedstock fluid. In certain embodiments, the housing unit and the rack unit are made of materials that are not susceptible to sparking or static discharge.

In certain embodiments, the removable units are configured with a rigid containment structure having a plurality of openings to allow fluid communication between the hydrocarbon feedstock fluid and the adsorbent. In certain embodiments, the rigid containment structure is configured to provide a rigid response to flow of a liquid bulk phase during transport, such that the adsorbent is retained within the removable units. In certain embodiments, the removable units are configured with a flexible containment structure having a plurality of openings to allow fluid communication between the hydrocarbon feedstock fluid and the adsorbent. In certain embodiments, the flexible containment structure is configured to provide a ductile and elastic response to the flow of the liquid bulk phase during transport, such that adsorbent is retained within the removable units. In certain embodiments, the removable units have a plurality of openings to allow for fluid communication between a liquid bulk phase and a surface phase adsorbent. In certain embodiments, the plurality of openings is in the form of fine mesh, a fabric, a fine netting, or another suitable arrangement of various materials of construction. In certain embodiments, the plurality of openings is sized to retain the adsorbent within the removable units.

In certain embodiments, the adsorbent is modified aluminosilicate, alumina, silica based materials, solid base, anionic ion exchange resin, solid acid, zeolite, cationic exchange resin, activated carbon, molecular sieve, Lewis acids, Lewis bases, metal organic framework, ion exchange resins, or mixed metal oxides. In certain embodiments, the absorbent is activated carbon having a uniform pore size, which may correspond to a molecular sieve. In certain embodiments, the adsorbent may be a powder, formed extrudate, shaped extrudate, spherical particles, sized particles, or aggregated particles. In certain embodiments, the removable units are configured to be cleared or drained of hydrocarbon feedstock fluid prior to removal from the transport container. In certain embodiments, the removable units are configured to have inert gas passed through a body of the removable units to clear the removable units of hydrocarbon feedstock fluid. In certain embodiments, the containment unity is configured to be cleared or drained of hydrocarbon feedstock fluid prior to extraction of the removable units from the transport container. In certain embodiments, adsorbent within the removable units may be replaced, regenerated, and/or recharged. In certain embodiments, the removable units may be replaced with fresh removable units after adsorbent within the removable units is spent, utilized, and/or at the end of a service life.

In certain embodiments, the transport container can be a tank truck, tank car, isocontainer, modular bulk chemical container, barge compartment, or chemical ship compartment. In certain embodiments, the transport container is equipped with one or more openings to facilitate insertion or extraction of the removable units. In certain embodiments, the hydrocarbon processing facility is a refinery or a chemical processing plant. In certain embodiments, the liquid bulk phase is the hydrocarbon feedstock fluid being transported in the transport container. In certain embodiments, the adsorbent is the surface phase contained within the removable units.

In certain embodiments, the transport container is configured to have a circulation system with piping and pumps to circulate the hydrocarbon feedstock fluid within the transport container when in a recycle mode. In certain embodiments, the transport container has a circulation system configured to discharge, move, or fill the transport container. In certain embodiments, the circulation system having piping and pumps of the transport container is configured to have a fixed bed containing adsorbent through which the hydrocarbon feed fluid can pass and be in fluid contact with the adsorbent.

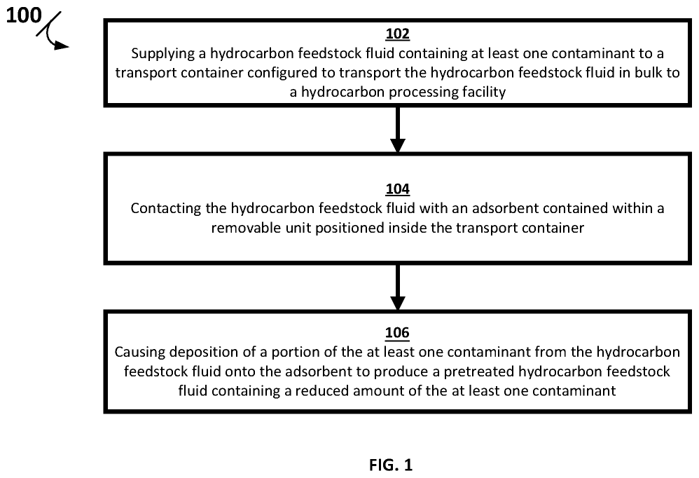

FIG. 1 is a diagrammatic representation of a method 100 for contacting a contaminated hydrocarbon feedstock fluid with an adsorbent for the removal of contaminants to create a pretreated hydrocarbon feedstock fluid during vehicular transport. This method 100 for processing a contaminated hydrocarbon feedstock fluid includes the step 102 of supplying a hydrocarbon feedstock fluid containing at least one contaminant to a transport container. The transport container is configured to transport the hydrocarbon feedstock fluid in bulk to a hydrocarbon processing facility. In certain embodiments, the hydrocarbon feedstock fluid is raw mixed waste plastic pyrolysis oil. In certain embodiments, the hydrocarbon feedstock fluid is naphtha or gas condensates. In certain embodiments, transporting the hydrocarbon feedstock fluid in bulk refers to transporting at least a threshold amount or volume of the hydrocarbon feedstock fluid. For example, the threshold amount may be an amount that fills at least half of the transport container, in certain embodiments.

In certain embodiments, the hydrocarbon feedstock fluid contaminants are one or more diolefin compounds, and halogen, nitrogen, sulfur, and/or oxygen compounds. In certain embodiments, the adsorbent in the one or more removable units is an aluminosilicate or silica based material that is suitable to remove one or more diolefin compounds, oxygen compounds, nitrogen compounds, and/or halogen compounds present as contaminants in the hydrocarbon feedstock fluid. In certain embodiments, the adsorbent in the one or more removable units is a solid base or an anionic exchange resin that is suitable to remove one or more oxygen compounds present as contaminants in the hydrocarbon feedstock fluid. In certain embodiments, the adsorbent in the one or more removable units is a solid acid, a zeolite, or a cationic exchange resin that is suitable to remove one or more halogen compounds present as contaminants in the hydrocarbon feedstock fluid. In certain embodiments, the adsorbent in the one or more removable units is a molecular sieve that is suitable to remove one or more diolefin compounds, oxygen compounds, nitrogen compounds, and/or halogen compounds present as contaminants in the hydrocarbon feedstock fluid. In certain embodiments, the removable unit contains an activated carbon adsorbent that is suitable to remove the one or more diolefin compounds, oxygen compounds, nitrogen compounds, and/or halogen compounds from the hydrocarbon feedstock fluid.

The method 100 further includes the step 104 of contacting the hydrocarbon feedstock fluid with an adsorbent within one or more removable units positioned inside the transport container. The removable units are positioned inside the transport container and configured to provide fluid communication between the hydrocarbon feedstock fluid and the adsorbent. In certain embodiments, transporting the transport container facilitates circulation, agitation, or mixing within the transport container to facilitate adsorption of contaminants from the hydrocarbon feedstock fluid. For example, acceleration of a vehicle moving the transport container may cause movement of the hydrocarbon feedstock fluid toward a back surface of the transport container, while deceleration may cause movement toward a front surface. Certain embodiments may additionally or alternatively include a circulation system that provides forced circulation or powered circulation within the transport container, independent of movement of the transport container. Certain non-limiting examples of the removable units are discussed in more detail below. As used herein, removable units refer to adsorbent-retaining entities that are removable, separable, and/or decouplable from the transport container or features thereof without causing damage to any contaminant removal system component.

The method 100 also includes the step 106 of causing deposition of a portion of at least one contaminant from the hydrocarbon feedstock fluid onto the adsorbent to produce a pretreated hydrocarbon feedstock fluid. The pretreated hydrocarbon feedstock fluid contains a reduced amount of the at least one contaminant compared to the initially provided hydrocarbon feedstock fluid. The method 100 results in a reduction of about 10 weight percent (wt. %) or more of one or more diolefin compounds, oxygen compounds, nitrogen compounds, and/or halogen compounds present in the hydrocarbon feedstock fluid. In some embodiments, the reduction of one or more diolefin compounds, oxygen compounds, nitrogen compounds, and/or halogen compounds present in the hydrocarbon feedstock fluid can range from about 10 wt. % to about 60 wt. %.

In certain embodiments, adsorbent within the removable units may be regenerated after the deposition of the portion of the at least one contaminant thereon. For example, the adsorbent may be regenerated after the removable unit is removed from the transport container, and then the regenerated removable unit may be utilized again. In certain embodiments, the removable units may be modular entities that can be replaced after the deposition of the at least one contaminant. The methods described herein therefore provide efficient conditioning or decontamination of the hydrocarbon feedstock fluid during transportation. As such, cheaper feedstocks may be selected to benefit a material cost of the hydrocarbon processing facility receiving the pretreated hydrocarbon feedstock fluid, in certain embodiments. Moreover, combining decontamination operations with transportation operations as disclosed herein may improve an operating schedule of the hydrocarbon processing facility compared to facilities that decontaminate fluids after arrival, in certain embodiments.

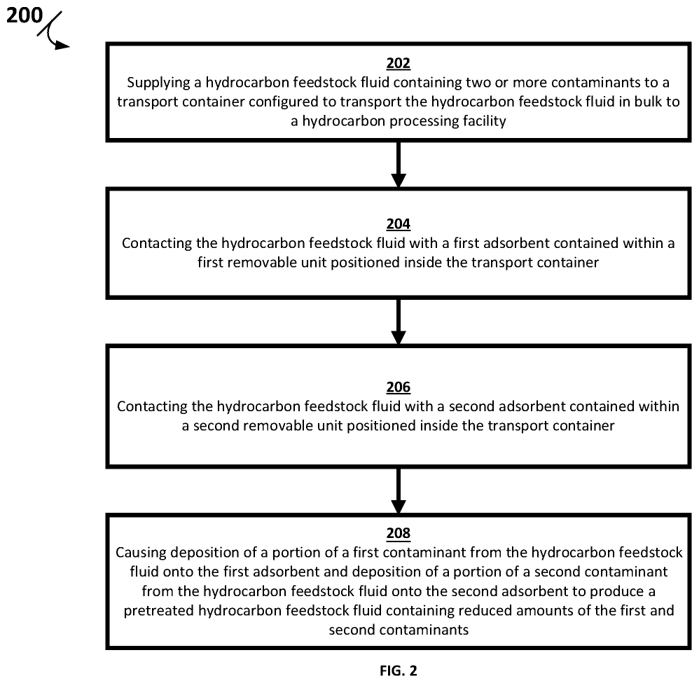

FIG. 2 is a diagrammatic representation of a method 200 for contacting a contaminated hydrocarbon feedstock fluid with a first adsorbent and a second adsorbent for the removal of a first contaminant and a second contaminant to create a pretreated pyrolysis oil during vehicular transport. This method 200 for processing a contaminated hydrocarbon feedstock fluid includes the step 202 of supplying a hydrocarbon feedstock fluid containing two or more contaminants to a transport container. The transport container is configured to transport the hydrocarbon feedstock fluid in bulk to a hydrocarbon processing facility. In certain embodiments, the hydrocarbon feedstock fluid is raw mixed waste plastic pyrolysis oil. In certain embodiments, the hydrocarbon feedstock fluid is naphtha or gas condensates.

The method 200 further includes the step 204 of contacting the hydrocarbon feedstock fluid with a first adsorbent contained within a first removable unit positioned inside the transport container. The first removable unit is configured to provide fluid communication between the hydrocarbon feedstock fluid and the first adsorbent. In certain embodiments, the first adsorbent in the first removable unit is activated carbon, aluminosilicate, or silica based materials to remove diolefin compounds, oxygen compounds, nitrogen compounds, or halogen compounds present as at least one of the contaminants in the hydrocarbon feedstock fluid.

The method 200 further includes the step 206 of contacting the hydrocarbon feedstock fluid with a second adsorbent within a second removable unit positioned inside the transport container. The second removable unit is configured to provide fluid communication between the hydrocarbon feedstock fluid and the second adsorbent. In certain embodiments, the second adsorbent in the second removable unit is a solid base or an anionic exchange resin to remove one or more oxygen compounds present as at least one of the contaminants in the hydrocarbon feedstock fluid. In certain embodiments, the second adsorbent in the second removable unit is one or more of a solid acid, a zeolite, or a cationic exchange resin to remove one or more of halogen compounds present as at least one of the contaminants in the hydrocarbon feedstock fluid.

The method 200 also includes the step 208 of causing the deposition of a portion of a first contaminant from the hydrocarbon feedstock fluid onto the first adsorbent and deposition of a portion of a second contaminant from the hydrocarbon feedstock fluid onto the second adsorbent to produce a pretreated hydrocarbon feedstock fluid. The pretreated hydrocarbon feedstock fluid contains reduced amounts of the two or more contaminants. The method 200 results in a reduction of about 10 weight percent (wt. %) or more of two or more diolefin compounds, oxygen compounds, nitrogen compounds, and/or halogen compounds present in the hydrocarbon feedstock fluid. In some embodiments, the reduction of the two or more diolefin compounds, oxygen compounds, nitrogen compounds, and/or halogen compounds present in the hydrocarbon feedstock fluid can range from about 10 wt. % to about 60 wt. %. Accordingly, the method 200 facilitates the removal of at least two distinct contaminants from the hydrocarbon feedstock fluid during transportation to the hydrocarbon processing facility. In certain embodiments, the method 200 may be extended to include the addition of a third adsorbent to remove a third contaminant, a fourth adsorbent to remove a fourth contaminant, and so forth.

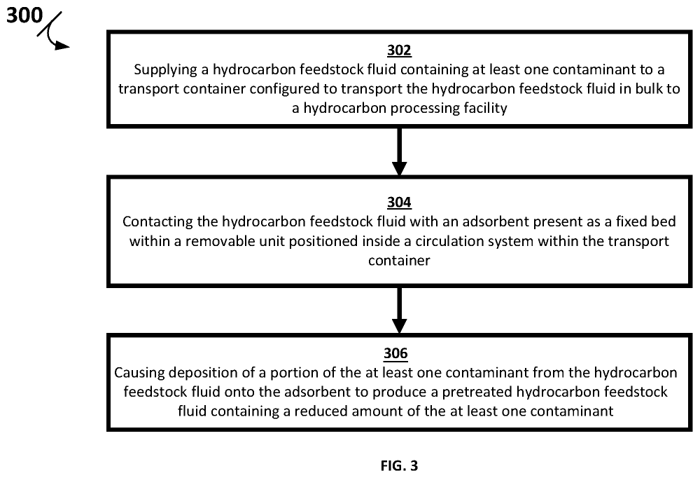

FIG. 3 is a diagrammatic representation of a method 300 for contacting a contaminated hydrocarbon feedstock fluid with an adsorbent present as a fixed bed within a removable unit positioned within the transport container, including a pump to circulate the hydrocarbon feedstock fluid within the adsorbent fixed bed to create a pretreated hydrocarbon feedstock fluid (e.g., pretreated pyrolysis oil, pretreated naphtha) during vehicular transport. This method 300 for processing or conditioning a contaminated hydrocarbon feedstock fluid includes the step 302 of supplying a hydrocarbon feedstock fluid containing at least one contaminant to a transport container. The transport container is configured to transport the hydrocarbon feedstock fluid in bulk to a hydrocarbon processing facility, such as during a transportation time period. In certain embodiments, the hydrocarbon feedstock fluid is raw mixed waste plastic pyrolysis oil. In certain embodiments, the hydrocarbon feedstock fluid is naphtha or gas condensates. In certain embodiments, the transport container is configured to maintain a pyrolysis oil temperature of between about 15° C. to about 35° C. In certain embodiments, the fixed bed is configured or manufactured with a guard bed or prefilter to remove any solid contaminants present in the hydrocarbon feedstock fluid. In certain embodiments, the fixed bed is configured with a preheater to liquefy pyrolysis oil components having melting points higher than the bulk liquid. In certain embodiments, the transport container is configured with heating elements to liquefy pyrolysis oil components having melting points higher than the bulk liquid. The hydrocarbon feedstock fluid is therefore transformed into a fluid that is suitable for decontamination via the removable unit.

The method 300 further includes the step 304 of contacting the hydrocarbon feedstock fluid with an adsorbent present as a fixed bed within the removable unit positioned inside the transport container. The removable unit is configured or equipped with a pump to provide fluid circulation of the hydrocarbon feedstock fluid through the fixed bed of the adsorbent. In certain embodiments, the adsorbent in the removable unit is one or more aluminosilicate or silica based materials to remove one or more diolefin compounds, oxygen compounds, nitrogen compounds, and/or halogen compounds present as contaminants in the hydrocarbon feedstock fluid. In certain embodiments, the adsorbent in the removable unit is a solid base or an anionic exchange resin to remove one or more oxygen compound present as the contaminant in the hydrocarbon feedstock fluid. In certain embodiments, the adsorbent in the removable unit is one or more of a solid acid, a zeolite, or a cationic exchange resin to remove one or more halogen compounds present as the contaminant in the hydrocarbon feedstock fluid. In certain embodiments, the removable unit contains an activated carbon adsorbent to remove one or more diolefin compounds, oxygen compounds, nitrogen compounds, and/or halogen compounds from the hydrocarbon feedstock fluid. In certain embodiments, one or more additional removable units having respective adsorbents suitable for removing additional contaminants may also be positioned inside the transport container. The one or more additional removable units may operate independently of one another, in certain embodiments. Moreover, each removable unit may be positioned to operate in parallel or in series with other removable units within the transport container, in certain embodiments.

The method 300 also includes the step 306 of causing the deposition of a portion of at least one contaminant from the hydrocarbon feedstock fluid onto the adsorbent to produce a pretreated hydrocarbon feedstock fluid. The pretreated hydrocarbon feedstock fluid contains a reduced amount of the at least one contaminant. The method 300 results in a reduction of about 10 weight percent (wt. %) or more of one or more diolefin compounds, oxygen compounds, nitrogen compounds, and/or halogen compounds present in the hydrocarbon feedstock fluid. In some embodiments, the reduction of one or more diolefin compounds, oxygen compounds, nitrogen compounds, and/or halogen compounds present in the hydrocarbon feedstock fluid can range from about 10 wt. % to about 60 wt. %.

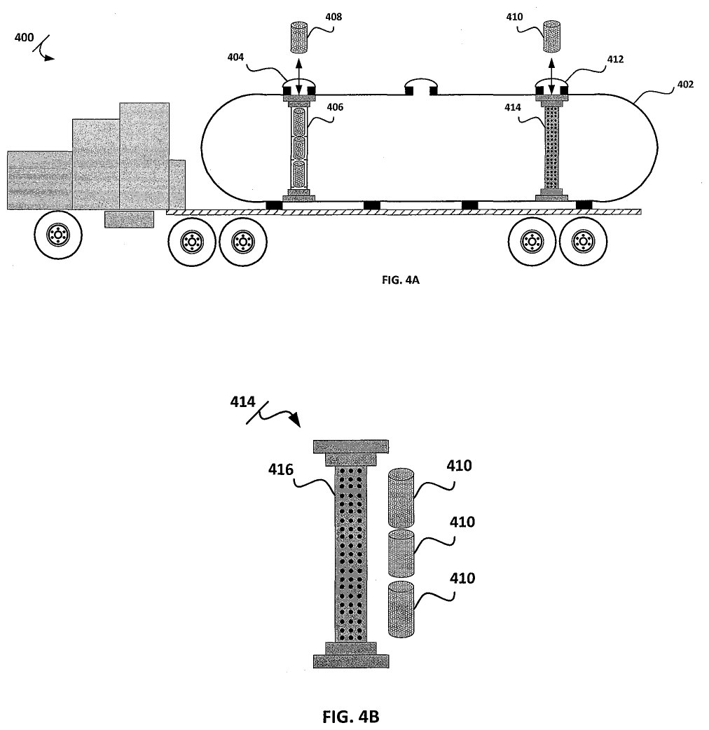

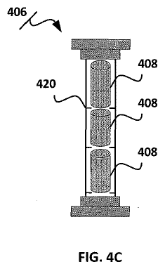

FIG. 4A is a diagrammatic representation of a transport system 400. This system 400 includes a transport container 402, a tank truck, and at least one of containment unities 406 and 414 to secure removable units 408 and 410 within the transport container 402. The containment unity 406 is connected to an opening 404 of the transport container 402 to insert or extract the removable units 408 from the containment unity 406. The containment unity 414 is connected to an opening 412 of the transport container 402 to insert or extract the removable units 410 from the containment unity 414. The openings 404, 412 are apertures or ports that are suitably sized for receiving the containment unities 406, 414. The containment unities 406, 414 are illustrated as extending vertically along a full inner height of the transport container 402, although other heights and alignments of the containment unities 406, 414 are contemplated herein. For example, the containment unities 406, 414 may extend horizontally through a full width of the transport container 402. In such embodiments, the openings 404, 412 may be formed near a top edge or surface of the transport container 402 to enable the removable units 408, 410 to be inserted or removed while fluid is within the transport container 402.

In other embodiments, the transport container 402 includes a single one of the containment unity 406 or the containment unity 414. In other embodiments, the transport container 402 may include two or more of the containment unities 406 or two or more of the containment unities 414. Indeed, the present embodiments outline certain examples of transport systems 400 and corresponding removable units 408, 410 for decontaminating a hydrocarbon feedstock fluid during transportation. As the tank truck of the illustrated transport system 400 moves between an initial destination and a final destination, motion of the tank truck may propagate through the transport container to facilitate mixing of the hydrocarbon feedstock fluid through the containment unities 406, 414 for contaminant removal therein.

FIG. 4B is a diagrammatic representation of the containment unity 414 with a housing unit 416 and removable units 410. The housing unit 416 is a cylinder that encases at least one of removable units 410. In other embodiments, the housing unit 416 is a rectangular prism and the removable units 410 have a corresponding shape. The housing unit 416 is configured with a plurality of openings to allow for fluid communication between the removable units 410 and the hydrocarbon feedstock fluid. The removable units 410 are configured to contain the adsorbent and the housing unit 416 is configured to secure the removable units 410 within the containment unity 414. Each of the removable units 410 include a body defining a plurality of channels to provide fluid communication between the hydrocarbon feedstock fluid and the adsorbent. In certain embodiments, the housing unit 416 and/or the removable units 410 are formed from a mesh or netting material to provide sufficient open surface area for fluid communication between the adsorbent and the hydrocarbon feedstock fluid. In certain embodiments, the housing unit 416 receives a single, elongated removable unit 410 instead of multiple, shorter removable units 410.

FIG. 4C is a diagrammatic representation of a containment unity 406 with a rack unit 420 and removable units 408. The rack unit 420 is a rack supporting at least one of removable units 408. The rack unit 420 is open to allow for fluid communication between the removable units 408 and the hydrocarbon feedstock fluid. For example, the rack unit 420 may be nearly or fully open along at least one surface thereof to expose a majority of the removable units 410 for fluid communication. The removable units 408 are configured to contain the adsorbent and the rack unit 420 is configured to secure the removable units 408 within the containment unity 406. Each of the removable units 408 include a body defining a plurality of channels to provide fluid communication between the hydrocarbon feedstock fluid and the adsorbent.

### EXAMPLES

### Example 1

Contaminated pyrolysis oil feed, 50 mL, was added to a flask containing 0.75 g (1.5 wt. %) of adsorbent. The adsorbent was weighed using a Mettler Toledo XPR204 microbalance. The flask was capped with an aluminum cap fitted with a rubber seal. The flask was shaken on a rotating shaker (Heidolph Reax 2, setting 6-7) for 24 hours. The flask was removed from the shaker and allowed to sit for 10 minutes to allow the adsorbent solids to settle. The flask was opened and a pyrolysis oil sample was extracted with a needle equipped with a glass syringe. Some adsorbent was carried with the extracted pyrolysis oil and was removed using a syringe filter (Agilent Captiva, 15 mm diameter glass fiber/PTFE membrane with a 0.2 μm pore size). The shaken and filtered pyrolysis oil sample was analyzed for various contaminants, as described in Table 1 displayed below. The test for repeated for additional concentrations of adsorbent, including 0.1 g (0.2 wt. %) and 0.4 g (0.8 wt. %).

TABLE 1
Test Methods for Determining Pyrolysis Fluid Properties

| Contaminant | Test Method |
|---|---|
| Organic Nitrogen Compounds | ASTM D4629, GC-NCD |
| Boiling Point Curves | SIMDis D2887 |
| Organic Chlorides | UOP 779 (SGS) |
| Bromine | ASTM D2710M ASTM D1159 |
| Paraffins, Naphthenes, | GC*GC-GT |
| Aromatics, Heavies | |
| Inorganics | Microwave assisted acid |
| | digestion, ICP-MS |

The results of organic chlorides and organic nitrogen compound reduction in pyrolysis oil from shaking with adsorbent for 24 hours is shown below in Table 2.

TABLE 2
Results of Contaminant Removal from Pyrolysis Oil by Adsorbent.

| | Total Organic | | | | |
|---|---|---|---|---|---|
| | Chlorides | | | Total Organic | |
| | Remaining, | % Cl | | Nitrogen, | % N |
| Adsorbent | (ppm w Cl) | Removal | Adsorbent | (ppm w N) | Removal |
| Blank | 148 | — | Blank | 1328 | — |
| C150S | 65 | 56 | CT275 | 528 | 60 |
| FX-20 | 68 | 54 | Mn502 | 665 | 49 |
| A500 OHPlus | 69 | 53 | C935 | 782 | 41 |
| 13X 100-120 | 75 | 49 | CASPF | 810 | 39 |
| FX-30 | 85 | 42 | DLS19-0117 | 842 | 37 |
| DLS19-0117 | 87 | 41 | SGL 8x30 | 849 | 36 |

### Example 2

Into a flask was added 1.5 g of activated carbon (roughly 3% of adsorbent), followed by 50 mL of contaminated pyrolysis oil feed. The flask was capped with an inert atmosphere and placed in a dark cabinet for up to 216 hours. The adsorbent was weighed using a Mettler Toledo XPR204 microbalance. The flask was capped with an aluminum cap fitted with a rubber seal. Aliquots were taken after 24 hours, 48 hours, 168 hours, and 216 hours. Sample flasks for a blank/baseline, for a granular adsorbent, and for a powder adsorbent were removed from the cabinet and a pyrolysis oil sample was extracted with a needle equipped with a glass syringe. Some adsorbent was carried with the extracted pyrolysis oil and was removed using a syringe filter (Agilent Captiva, 15 mm diameter glass fiber/PTFE membrane with a 0.2 μm pore size). The pyrolysis oil sample was analyzed for organic nitrogen compounds and organic oxygen compounds by UV-Vis transmission. UV-Vis transmission measurements were performed using a Lovibond spectrophotometric colorimeter (PFX/880), with a 33 mm path length borosilicate glass cuvette. Monitoring of organic nitrogen compounds and organic oxygen compounds was performed at 600 nm. Table 3 below displays the progression of decontamination of the pyrolysis oil.

TABLE 3
The Improvement of Pyrolysis Color
After Exposure to Activated Carbon.

| | % Transmission @ 600 nm | | | | |
|---|---|---|---|---|---|
| | 0 Hrs | 24 Hrs | 48 Hrs | 168 Hrs | 216 Hrs |
| Blank | 0.32 | 0.1 | 0.5 | 0.3 | 0.3 |
| Sample 1, | 0.32 | 19.5 | 40.8 | 55.2 | 59.2 |
| granular adsorbent | | | | | |
| Sample 2, | 0.32 | 17.4 | 44.4 | 58.0 | 64.0 |
| powder adsorbent | | | | | |

The improvement of pyrolysis color, as measured by the increase in percent transmission after exposure to activated carbon (in both powder and granular form) in Table 3, can be correlated to the reduction in organic nitrogen compounds and organic oxygen compounds, as shown in Table 4. Percent transmission is the amount of visible light that is passing through the sample.

Table 4 provides the statistical significance that organic nitrogen compounds and organic oxygen compounds have on the percent transmission as described by the p-value and the log worth.

TABLE 4
The effect of organic nitrogen compounds and organic
oxygen compounds on percent transmission at 600 nm.

| | Organic | Organic |
|---|---|---|
| | Nitrogen | Oxygen |
| | Compounds | Compounds |
| Total Amount of Contaminant | 0.00000 | 0.00000 |
| (ppm), PValue | | |
| Total Amount of Contaminant | 14,490 | 11,500 |
| (ppm), Log Worth | | |
| Root Mean Square Error, RMSE | 35.09 | 202.41 |
| Coefficient of | 0.99 | 0.95 |
| Determination, RSq. | | |

The statistical significance of a parameter being tested or modeled is described by the p-value. A p-value of less than 0.0001 is considered statistically significant for an event to occur or not to occur. The log worth is the negative log 10 of the p-value. The root mean squared error (RMSE) of the actual percent transmission versus the predicted percent transmission for both organic nitrogen compound concentration (ppm) and organic nitrogen compound concentration (ppm) is shown. The predictive accuracy of the model is described by the coefficient of determination or root squared (RSq). A RSq value of greater than 0.90 is considered to indicate a high degree of predictive accuracy. The table results indicate that activated carbon removal of organic nitrogen compounds and organic oxygen compounds have a direct effect on the improvement of percent transmission at 600 nm. Accordingly, activated carbon is a suitable adsorbent for utilization within certain embodiments of the hydrocarbon pretreating methods and systems discussed above.

Other objects, features, and advantages of the disclosure will become apparent from the foregoing figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from the detailed description. In further embodiments, features from specific embodiments may be combined with features from other embodiments. For example, features from one embodiment may be combined with features from any of the other embodiments. In further embodiments, additional features may be added to the specific embodiments described herein.

What is claimed is:

1. A method of pretreating a hydrocarbon feedstock fluid in a transport container, the method comprising:
supplying a hydrocarbon feedstock fluid containing at least one contaminant to a transport container configured to transport the hydrocarbon feedstock fluid in bulk to a hydrocarbon processing facility, the at least one contaminant being one or more of diolefin compounds, oxygen compounds, nitrogen compounds, or halogen compounds;
contacting the hydrocarbon feedstock fluid with an adsorbent contained within a removable unit positioned inside the transport container, the removable unit being configured to provide fluid communication between the hydrocarbon feedstock fluid and the adsorbent; and
causing deposition of a portion of the at least one contaminant from the hydrocarbon feedstock fluid onto the adsorbent to produce a pretreated hydrocarbon feedstock fluid containing a reduced amount of the at least one contaminant.

2. The method of claim 1, wherein the removable unit comprises a plurality of channels providing the fluid communication between the hydrocarbon feedstock fluid and the adsorbent.

3. The method of any one of claims 1 or 2, comprising transporting the transport container to the hydrocarbon processing facility while contacting the hydrocarbon feedstock fluid with the adsorbent to provide circulation within the transport container.

4. The method of any one of claims 1-3, wherein the adsorbent in the removable unit comprises aluminosilicate or silica based materials to remove the one or more of the diolefin compounds, the oxygen compounds, the nitrogen compounds, or the halogen compounds from the hydrocarbon feedstock fluid.

5. The method of any one of claims 1-4, wherein the adsorbent in the removable unit comprises a solid base or an anionic exchange resin to remove at least one oxygen compound of the oxygen compounds from the hydrocarbon feedstock fluid.

6. The method of any one of claims 1-5, wherein the adsorbent in the removable unit comprises one or more of a solid acid, a zeolite, or a cationic exchange resin to remove at least one halogen compound of the halogen compounds from the hydrocarbon feedstock fluid.

7. The method of any one of claims 1-6, wherein the removable unit contains a molecular sieve adsorbent to remove the one or more of the diolefin compounds, the oxygen compounds, the nitrogen compounds, or the halogen compounds from the hydrocarbon feedstock fluid.

8. A method of pretreating a hydrocarbon feedstock fluid in a transport container, the method comprising:
supplying a hydrocarbon feedstock fluid containing two or more contaminants to a transport container configured to transport the hydrocarbon feedstock fluid in bulk to a hydrocarbon processing facility, the two or more contaminants being diolefin compounds, oxygen compounds, nitrogen compounds, halogen compounds, or combinations thereof;
contacting the hydrocarbon feedstock fluid with a first adsorbent contained within a first removable unit positioned inside the transport container, the first removable unit being configured to provide fluid communication between the hydrocarbon feedstock fluid and the first adsorbent;
contacting the hydrocarbon feedstock fluid with a second adsorbent contained within a second removable unit positioned inside the transport container, the second removable unit being configured to provide fluid communication between the hydrocarbon feedstock fluid and the second adsorbent; and
causing deposition of a portion of a first contaminant from the hydrocarbon feedstock fluid onto the first adsorbent and deposition of a portion of a second contaminant from the hydrocarbon feedstock fluid onto the second adsorbent to produce a pretreated hydrocarbon feedstock fluid containing reduced amounts of the first contaminant and the second contaminant.

9. The method of claim 8, wherein the hydrocarbon feedstock fluid is raw mixed plastic waste pyrolysis oil.

10. The method of claim 8, wherein the hydrocarbon feedstock fluid is naphtha or gas condensate.

11. The method of one or more of claims 8-10, wherein the first adsorbent in the first removable unit is activated carbon, aluminosilicate, or silica based materials to remove at least one of the diolefin compounds, the oxygen compounds, the nitrogen compounds, or the halogen compounds from the hydrocarbon feedstock fluid.

12. The method of one or more of claims 8-11, wherein the second adsorbent in the second removable unit is a solid base or an anionic exchange resin to remove at least one oxygen compound of the oxygen compounds from the hydrocarbon feedstock fluid.

13. The method of one or more of claims 8-11, wherein the second adsorbent in the second removable unit is one or more of a solid acid, a zeolite, or a cationic exchange resin to remove at least one halogen compound of the halogen compounds from the hydrocarbon feedstock fluid.

14. The method of one or more of claims 8-10, wherein the first adsorbent in the first removable unit is a solid base or an anionic exchange resin to remove at least one oxygen compound of the oxygen compounds from the hydrocarbon feedstock fluid and the second adsorbent in the second removable unit is one or more of a solid acid, a zeolite, or a cationic exchange resin to remove at least one halogen compound of the halogen compounds from the hydrocarbon feedstock fluid.

15. A method of pretreating a hydrocarbon feedstock fluid in a transport container, the method comprising:
supplying a hydrocarbon feedstock fluid containing at least one contaminant to a transport container configured to transport the hydrocarbon feedstock fluid in bulk to a hydrocarbon processing facility, the at least one contaminant being one or more of diolefin compounds, oxygen compounds, nitrogen compounds, or halogen compounds;
contacting the hydrocarbon feedstock fluid with an adsorbent present as a fixed bed within a circulation system positioned inside the transport container, the circulation system equipped with a pump to circulate the hydrocarbon feedstock fluid through the fixed bed of the adsorbent; and
causing deposition of a portion of the at least one contaminant from the hydrocarbon feedstock fluid onto the adsorbent to produce a pretreated hydrocarbon feedstock fluid containing a reduced amount of the at least one contaminant.

16. The method of claim 15, wherein the hydrocarbon feedstock fluid is raw mixed plastic waste pyrolysis oil.

17. The method of claim 15, wherein the hydrocarbon feedstock fluid is naphtha or gas condensate.

18. The method of any one of claims 15-17, wherein the adsorbent in the fixed bed comprises one or more of aluminosilicate or silica based materials to remove the one or more of the diolefin compounds, the oxygen compounds, the nitrogen compounds, or the halogen compounds from the hydrocarbon feedstock fluid.

19. The method of any one of claims 15-18, wherein the adsorbent in the fixed bed comprises one or more of a solid base or an anionic exchange resin to remove at least one oxygen compound of the oxygen compounds from the hydrocarbon feedstock fluid.

20. The method of any one of claims 15-19, wherein the adsorbent in the fixed bed comprises one or more of a solid acid, a zeolite, or a cationic exchange resin to remove at least one halogen compound of the halogen compounds from the hydrocarbon feedstock fluid.
